(19) United States
(12) Patent Application Publication
(10) Pub. No.: US 2025/0108914 A1
(43) Pub. Date: Apr. 3, 2025

(54) VTOL System for Fixed Winged Aircraft

(71) Applicant: Gregorio Melodia Belloso, Salisbury, MD (US)

(72) Inventor: Gregorio Melodia Belloso, Salisbury, MD (US)

(21) Appl. No.: 18/500,908

(22) Filed: Nov. 2, 2023

Related U.S. Application Data
(63) Continuation-in-part of application No. 29/913,345, filed on Sep. 29, 2023.

(51) Int. Cl. B64C 29/00

(52) U.S. Cl. CPC B64C 29/0025

(57) ABSTRACT

A system and assembly allowing vertical take off and landing (VTOL) operations for winged aircraft may include a housing and one or more rotors. The rotors may be positioned within slots on the housing, each slot having an upper and lower aperture to allow airflow. The rotors may be connected to a control system in the cockpit to allow for control over the angle and power of the rotors during flight. A protective cover may be placed over one or both of the apertures, the covers being either slidably or hingedly openable. A supporting member may provide space between the aircraft and the housing. The system may be retrofitted to existing aircraft, or included in their manufacture. The system is intended for use with personal small aircraft, military aircraft, and commercial airliners.

The current application claims a priority to the U.S. Design patent application Ser. No. 29/913,345 filed on Sep. 29, 2023.

### FIELD OF THE INVENTION

The present invention relates generally to aircraft assemblies. More specifically, the present invention relates to a vertical take-off and landing (VTOL) system directed towards allowing fixed wing aircraft to perform VTOL operations.

### BACKGROUND OF THE INVENTION

Aircraft takeoff areas require a great deal of land and space. The presence of any nearby obstacles can greatly hinder the liftoff of any aircraft, as aircraft such as airplanes require long straight line paths such as runways to achieve liftoff. As such, there is a desire for improved systems capable of allowing aircraft to achieve vertical takeoff and landing (VTOL).

Increased interest in VTOL fixed wing aircraft is driven by the capability of fixed wing aircraft to fly much faster than rotary wing aircraft like the helicopter. There are two types of VTOL fixed wing aircraft in use, by the military, and each type has its own limitations. The tilt-rotor type, exemplified by the Osprey, is driven by propeller and is limited to speeds below 400 miles per hour. The ducted fan type, exemplified by the Harrier jump jet and the F35 fighter plane, is unsuitable for taking off and landing on unprepared fields due to excessive velocity of the downwardly directed air stream which severely erodes the landing surface. This present invention avoids these two limitations by using lifting rotors like those used in drones and helicopters, and by being applicable for use in jet powered aircraft without causing limitations in flight speed. It is accordingly the objective of this invention to provide a system that can be incorporated in the manufacture of fixed wing aircraft or retrofitted into an existing aircraft that would make said aircraft capable of taking off and landing vertically on unprepared ground.

It is another objective of this invention to provide a system that does not cause any fundamental operational speed limitations to the aircraft so that it can be used in a wide variety of military and civilian aircraft. It is still an additional objective of this invention to provide an aircraft that is capable of taking off and landing at lower air speed to reduce the frequency and severity of speed related accidents in airports, and during emergency landings elsewhere. It is yet another objective to provide a system that can be powered by pneumatic motors, combustion engines or by battery-driven electric motors, or by any combination of these. It is still a further objective of this invention to provide a system that makes maximal use of current state-of-the-art technology and off-the-shelf components. These objectives and other objectives and advantages of the invention will be apparent from the following description.

### SUMMARY OF THE INVENTION

In summary, the above and other beneficial objectives and advantages are accomplished in accordance with the present invention by a VTOL assembly fixedly attachable to, or included in the manufacture of a fixed wing aircraft, said assembly being of sufficient sturdiness to carry the fully loaded and fueled aircraft. Said VTOL assembly includes a plurality of multi-copter rotors capable of lifting said aircraft above the ground to a position suitable for horizontal flight. It further includes motor means having sufficient power capacity to cause said multi-copter rotors to lift said aircraft into the air. It further includes a power source for said motors, said power source being a choice of rechargeable batteries for electric motors, a holding tank for compressed air for pneumatic motors, or a gas tank for combustion engines. It further includes a control mechanism for the pilot to control full operation of this VTOL system for the aircraft. The fundamental feature of this invention is that it enables a fixed wing aircraft to take off vertically to land vertically, and to hover in a static position in the air. Furthermore, this invention also enables a fixed wing-aircraft to take off from airport runways at slower speed, and at shorter distances, an operation called STOL, short take-off and landing. Finally, as previously stated, it enables a fixed wing aircraft to perform VTOL operation from unprepared ground.

To that end, the VTOL system assembly may comprise a housing. The housing may have a tapered front and back end, reducing drag from airflow. The housing may contain one or more slots, each slot having an upper aperture and a lower aperture. One or more rotors may be positioned in each slot. Each rotor receives energy transmitted from a transmission device, the transmission device transmitting the energy from a motor device. The motor device may be powered by the energy source. The rotors are thus spun by the motor, causing the attached aircraft to lift vertically from the ground. Each aperture may have a cover that is hingedly or slidably openable, permitting the rotors to be covered and protected from the elements when not in use. The rotors may be controlled in operation, speed, pitch, yaw, or any other adjustment using a control system.

### BRIEF DESCRIPTION OF THE DRAWINGS

FIG. 1 shows a system diagram of elements of the present invention.

FIG. 2 shows a front perspective view of the present invention.

FIG. 3 shows a rear perspective view of the present invention.

FIG. 4 shows a top view of an embodiment of the present invention attached to a small aircraft.

FIG. 5 shows a top view of an embodiment of the present invention attached to a small aircraft.

FIG. 6 shows a side view of an embodiment of the present invention attached to a small aircraft.

FIG. 7 shows a front view of an embodiment of the present invention attached to a small aircraft.

FIG. 8 shows a top view of an embodiment of the present invention attached to a military aircraft.

FIG. 9 shows a side view of an embodiment of the present invention attached to a military aircraft.

FIG. 10 shows a front view of an embodiment of the present invention attached to a small aircraft.

FIG. 11 shows a top view of an embodiment of the present invention attached to a commercial aircraft.

FIG. 12 shows a side view of an embodiment of the present invention attached to a commercial aircraft.

FIG. 13 shows a top view of an embodiment of the present invention attached to a small aircraft, showing the auxiliary and main rotors.

FIG. 14 is a cross-sectional view of the upper and lower rotor an stator taken across line A-A of FIG. 13.

FIG. 15 shows a top view of an embodiment of the present invention attached to a commercial aircraft, showing the auxiliary and main rotors.

FIG. 16 shows a top view of an embodiment of the present invention attached to a military aircraft, showing the auxiliary and main rotors and the slidable protective cover.

### DETAILED DESCRIPTIONS OF THE INVENTION

All illustrations of the drawings are for the purpose of describing selected versions of the present invention and are not intended to limit the scope of the present invention.

It should be understood that the words “a”, “an” and “the” refer to both the singular and plural of the referenced component, unless explicitly stated otherwise. For example, reference to “a rotor” should be understood to include reference to “one rotor”, “one or more rotors”, and “a plurality of rotors”. It should further be understood that the term “rotor” as used in this document should be understood to encompass both rotors and fans, as is well-known in the art.

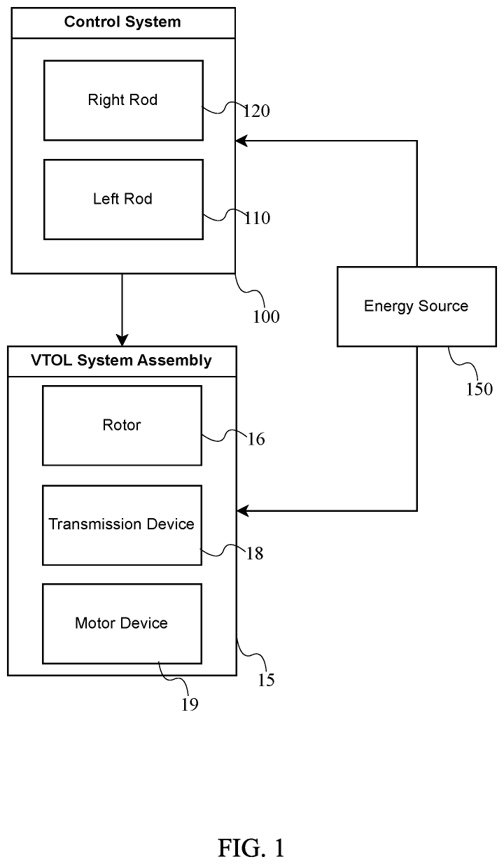

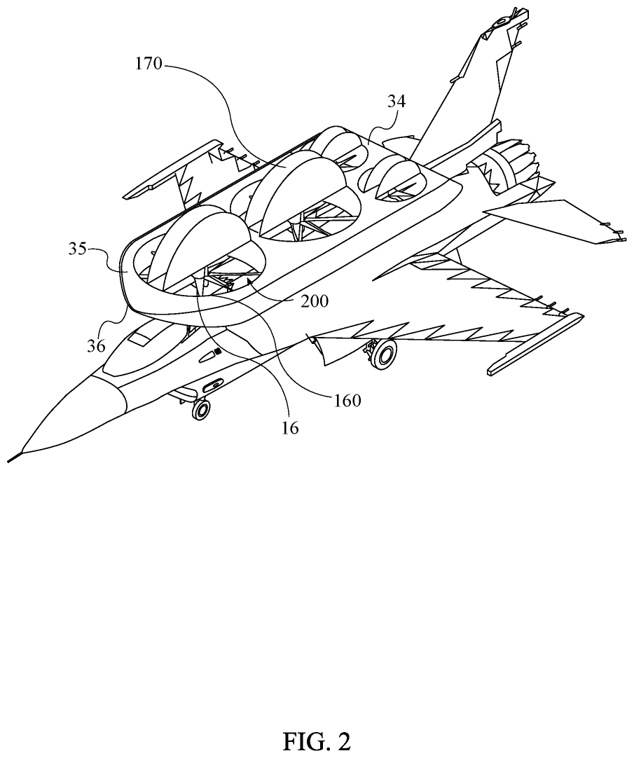

Referring now to the Figures, the present invention is a vertical take off and landing (VTOL) system. As shown in FIGS. 1-2, the VTOL system assembly 15 may comprise a rotor 16, a transmission device 18, a motor device 19, and a housing 35. In some embodiments, the VTOL system assembly 15 may further comprise an energy source 150 and a control system 100.

The VTOL system assembly 15 may be capable of being retrofit to an existing aircraft, such as by fastening the VTOL system assembly 15 to strongpoints on the fuselage of the aircraft, or by attaching the VTOL system assembly 15 to the aircraft via any other fastening means that is well known in the art. In some embodiments, the VTOL system assembly 15 may be manufactured and integrated directly into the aircraft, rather than retrofitting.

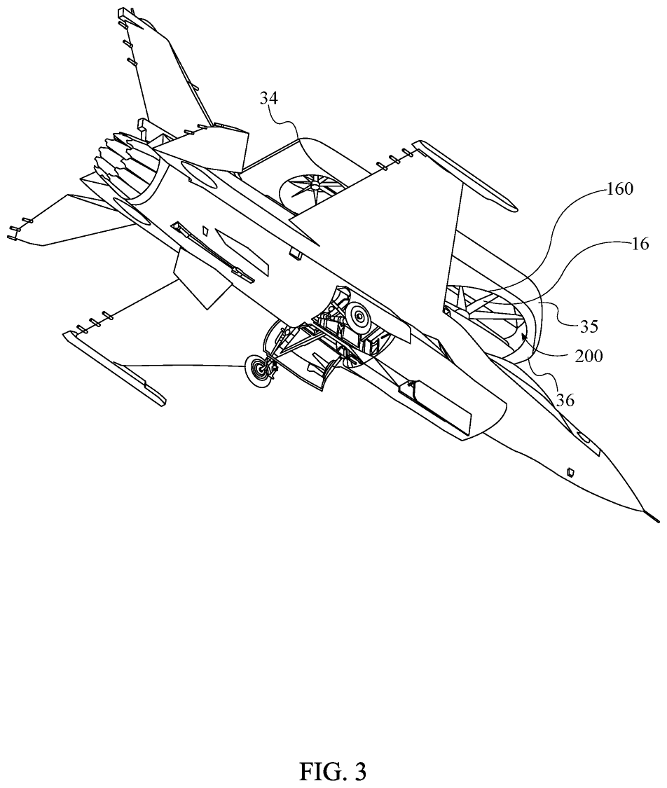

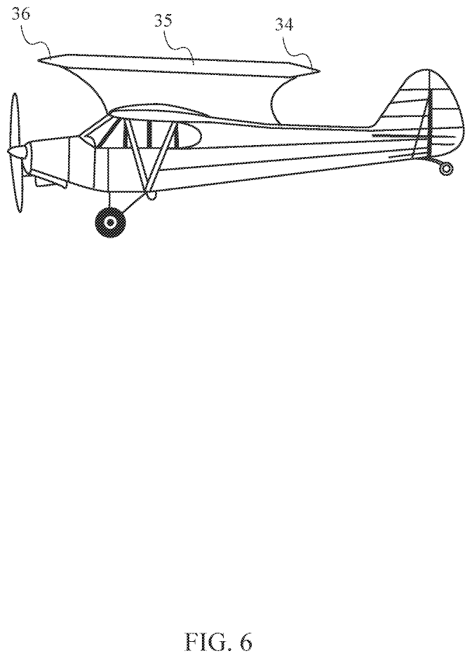

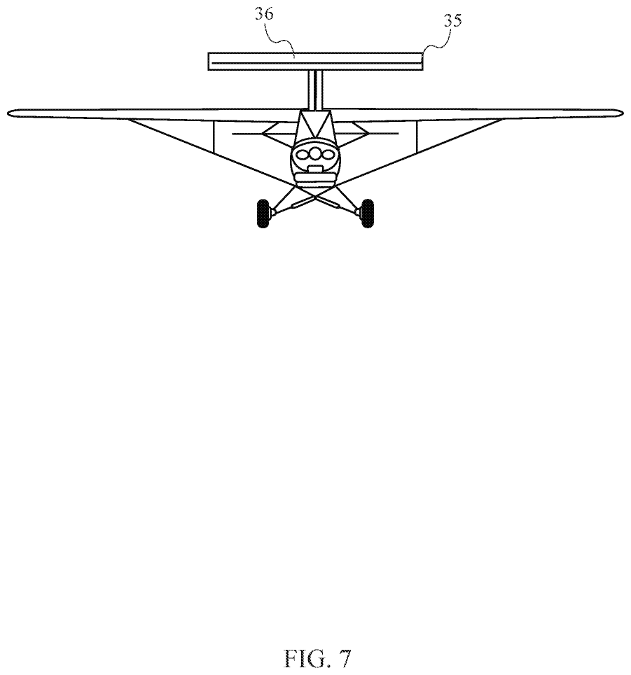

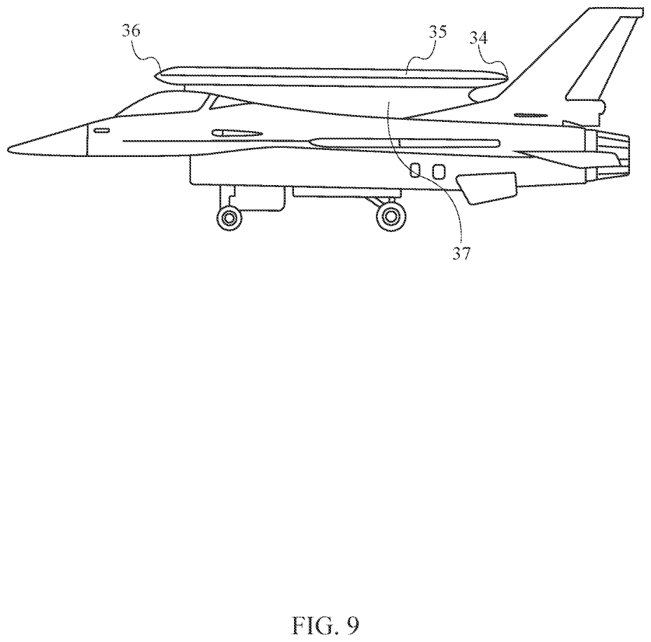

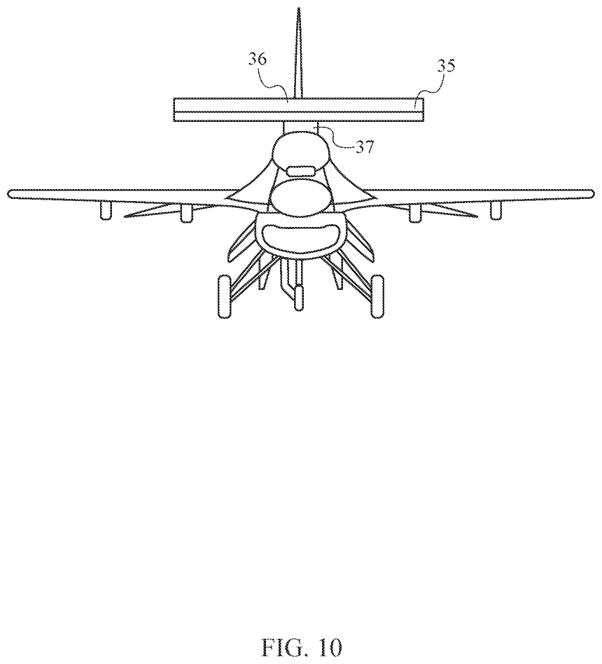

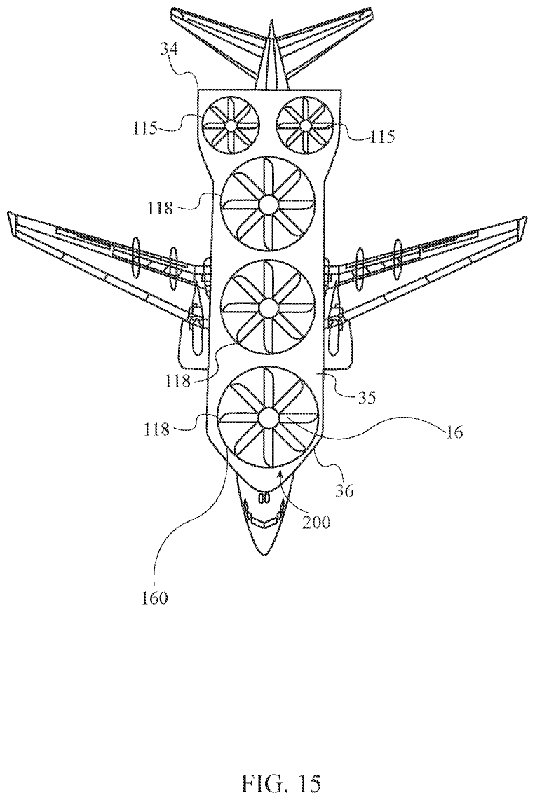

Referring now to FIGS. 2-13 and FIG. 15, the housing 35 may comprise a structure intended for housing the rotors 16. In some embodiments, the housing 35 may comprise a front edge 36 and a rear edge 34. The front edge 36 and rear edge 34 may be tapered to a point, or otherwise adapted to reduce wind resistance, providing better stability and speed for the aircraft. The housing 35 may comprise a slot 200 intended for housing 35 the rotor 16. The slot 200 may further comprise an aperture 160, ideally comprising an upper aperture 160 located on the top of the housing 35, and a lower aperture 160 located on the bottom of the housing 35. The rotor 16 may be positioned between the upper aperture 160 and lower aperture 160. In the ideal embodiment, the housing 35 may be positioned directly above the fuselage of an aircraft, being ideally positioned so that the center of vertical lift generated is located to be maximally close to the vertical axis of the aircraft. The housing 35 may be detachably attached or permanently affixed to the aircraft. However, as shown in FIGS. 2-3, the housing 35 should ideally have some space between the aircraft to enable the free flow of airflow to ensure proper operation of the rotors 16. The space may be created using a supporting member 37, described in more detail below. The use of a plurality of slots 200 is contemplated.

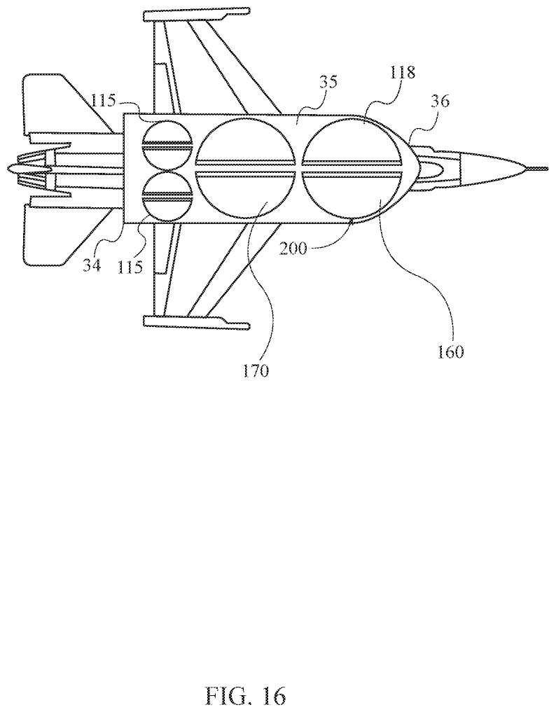

Referring now to FIGS. 2-3 and 16, in some embodiments, each aperture 160 may further comprise a protective cover 170. In some embodiments, as shown in FIGS. 2-3, the protective cover 170 opens and closes to cover or uncover the aperture 160 using a hinged mechanism, wherein the protective cover 170 is thus hingedly attached to the housing 35. In other embodiments, as shown in FIG. 16, the protective cover 170 may open and close using a sliding mechanism, wherein the protective cover 170 is adapted to slide into and out of the housing 35, such as by sliding into and out of a recess on the housing 35, such that the cover 170 is slidably attached to the housing 35. In one embodiment, there may be an upper cover 170 positioned on and attached to the upper aperture 160, and a lower cover 170 positioned on and attached to the lower aperture 160. In the ideal embodiment, the protective cover 170 or covers may be operatively connected to the control system 100, such that a signal may be sent using the control system 100 to actuate the protective cover 170 to open or close the protective cover 170 as the user desires.

The rotor 16 may comprise any rotor 16 well-known in the art. Ideally, the rotor 16 may comprise a plurality of rotor blades. The rotor 16 may be either a ducted rotor 16 or an unducted rotor 16. As shown in FIG. 1, in the ideal embodiment, the rotor 16 is operatively connected to the transmission device 18, such that the rotor 16 receives mechanical energy from the transmission device 18. The rotor 16 is positioned on the housing 35, ideally within the slot 200, between the upper aperture 160 and the lower aperture 160. In the ideal embodiment, the rotor 16 may be foldable, such that the rotor 16 is adapted to fold into the housing 35 when not in use, and extend into an operational position when in use. In the ideal embodiment, ducted, non-foldable rotors are used. Ducted, non-foldable rotors are known in the art to achieve better efficiency than non-ducted, foldable rotors.

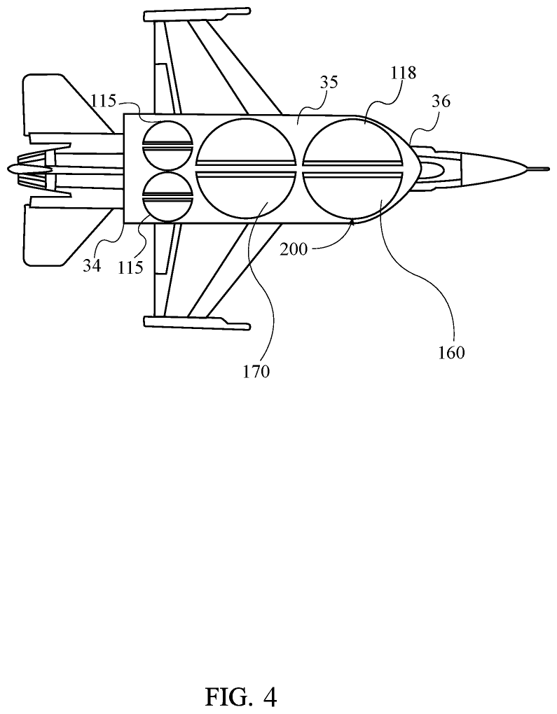

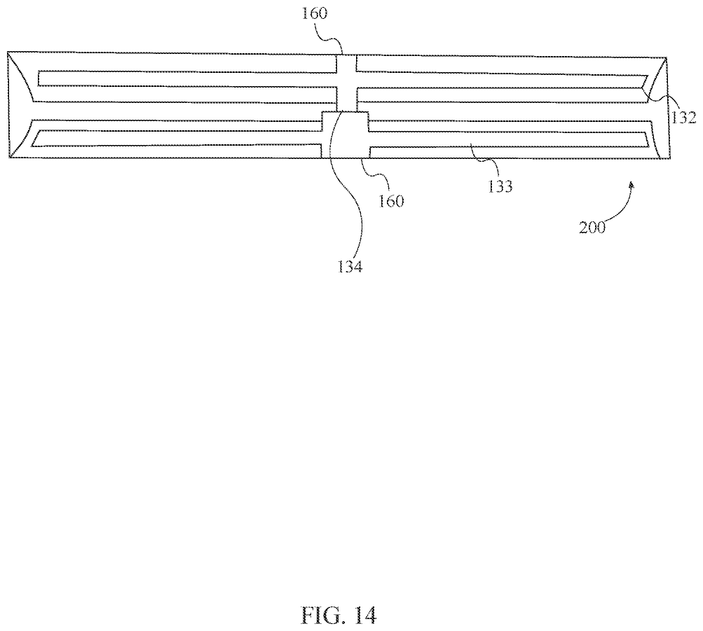

In one embodiment as shown in FIG. 4, a plurality of rotors 16 may be positioned in a single line, vertically above the fuselage of the aircraft. In another embodiment, a plurality of rotors 16 may be positioned in a single row longitudinally above the fuselage of the aircraft. In some embodiments, more than one rotor 16 may be placed into one slot 200 on the housing 35. For example, as shown in the cross-sectional view of FIG. 14, an upper rotor 132 may be positioned towards the upper aperture 160 in the upper half of the slot 200, and a lower rotor 133 may be positioned towards the lower aperture 160 in the lower half of the slot 200. In this embodiment, a stator blade 134 may be positioned between the upper and lower rotor 133, and the rotors 16 may be adapted to be contrarotating, as is well-known in the art. It should be understood that in any configuration, a plurality of rotors 16 may be used, for example, a plurality of upper rotors 16, a plurality of lower rotors 16, and a plurality of stators 134 are within the spirit and scope of the invention, with examples of different configurations, including variations of rows and columns of rotors, being shown in FIGS. 2-16. The rotation of each rotor 16 may be adjusted independently to achieve most stable flight, as is known in the art. For example, each rotor 16 may rotate in a direction opposite of adjacent rotors 16 (alongside, behind, or in front) to achieve the most consistent rotation.

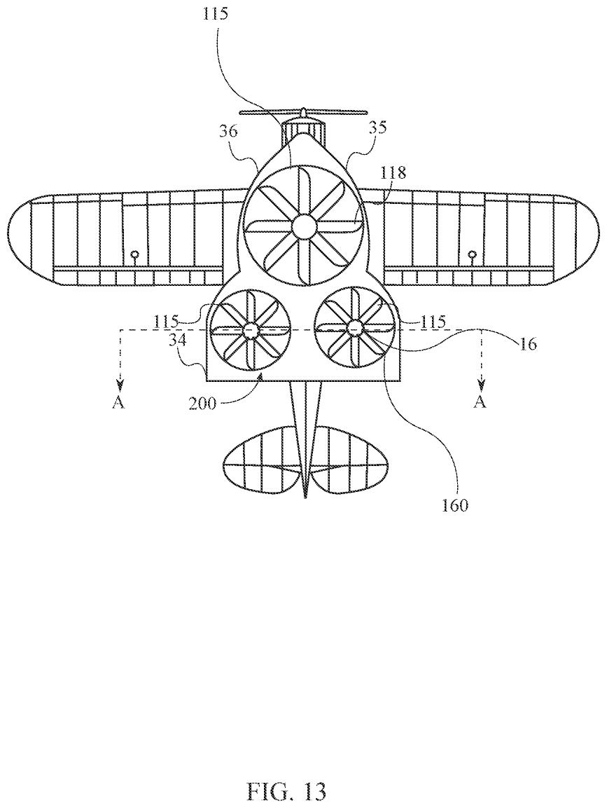

In other embodiments, as shown in FIGS. 13 and FIGS. 15-16, the rotors 16 may be subdivided into a main rotor 115 and an auxiliary rotor 118. The main rotor 115 is ideally static and is adapted to be larger to provide the maximum lift possible. In this embodiment, the auxiliary rotors 118 are ideally adapted to be smaller but also to rotate or be attached to a gimbal device, being able to control the pitch and roll of the aircraft.

Referring now to FIG. 1, the transmission device 18 may comprise any device for transmitting energy between devices, ideally being adapted to transmit mechanical energy between the motor device 19 and the rotor 16. In the ideal embodiment, the transmission device 18 is operatively connected to the motor device 19 to receive mechanical energy from the motor device 19, and further operatively connected to the rotor 16 to transmit the received mechanical energy to the rotor 16, allowing the rotor 16 to rotate. The motor device 19 rotates the transmission device 18, the transmission device 18 in turn rotating the rotor 16. It should be understood that the use of a plurality of motors, a plurality of transmission device 18, and a plurality of rotors 16 is contemplated. In this embodiment, each rotor 16 is operatively connected to a single motor of the plurality of motors using a transmission device 18 of the plurality of transmission device 18.

The motor device 19 may comprise any motor as is well-known in the art. In some embodiments, the motor device 19 may comprise an electric motor. In other embodiments, the motor device 19 may comprise a pneumatic motor driven by compressed air, the compressed air being stored from an on-board tank on the aircraft. In other embodiments, the motor device 19 may comprise an internal combustion engine, including a rotary engine or piston engine. In other embodiments, the motor device 19 may comprise a turboshaft jet engine. The embodiment using a turboshaft jet engine may include means to use turboshaft mechanisms powered by ducted turbofan outflows from the aircraft's regular turbofan engines, with or without afterburner means.

The energy source 150 may comprise any energy source 150 that is well-known in the art, and may be adapted to power the motor device 19. In some embodiments, the energy source 150 may comprise a rechargeable battery.

The control system 100 may comprise any control method of a VTOL system, quadcopter, or similar aircraft that is well-known in the art. The control system 100 may operatively connected by being either wired or wirelessly connected to the VTOL system assembly 15, such that the control system 100 is capable of transmitting commands, instructions, or direct the VTOL system assembly 15. For example, the control system 100 may comprise a dual vertical control rod system, comprising a left rod 110 and a right rod 120. The left rod 110 may be adapted to control vertical and yaw maneuvers, and the right rod 120 may control the pitch and roll. The control system 100 may be adapted to tilt or adjust the VTOL system assembly 15, or turn on or off portions of the VTOL system assembly 15 as needed by the user. The design of the control system 100 ensures that a qualified pilot will have the requisite skills to operate the VTOL system assembly 15, as the control system 100 is designed to be familiar and similar to existing aircraft.

A method of use is described for the above system herein. For an aircraft to take off vertically, first, the motor device 19 is started, and mechanical energy is transmitted through the transmission device 18 to spin any rotors 16. The rotors 16 lift the aircraft clear of any nearby obstructions. Once sufficient altitude is reached, the engine of the aircraft may be started and powered up, allowing the aircraft's propulsion system to take effect. Once the airspeed of the aircraft has exceeded the stalling speed, the VTOL system assembly 15 may be safely throttled down and stopped. In some embodiments, the rotors 16 may then be retracted into the housing or the protective covers 170 on the housing 35 may be closed.

To land an aircraft using the VTOL system assembly 15, the motor is restarted and powered up to rotate the rotors 16 while the aircraft is still in flight. Once enough lift is produced by the VTOL system assembly 15, the aircraft's propulsion system may be throttled down, and the aircraft may be subsequently flown and landed as a regular quadcopter, as is known in the art.

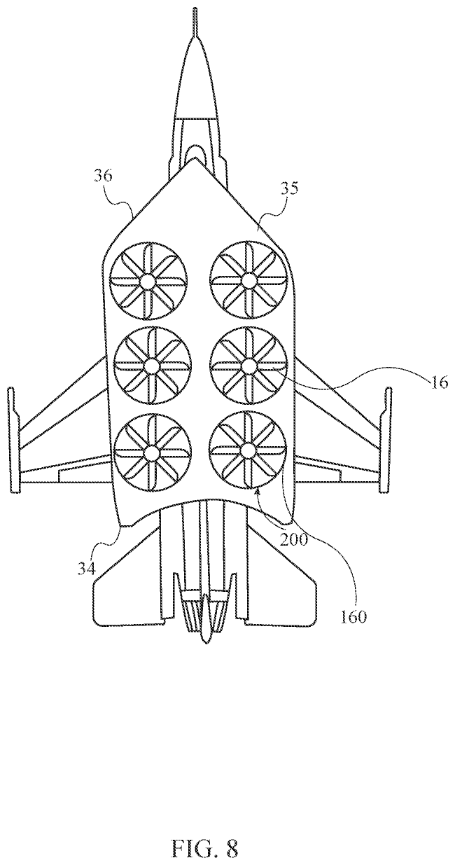

In some embodiments, the VTOL system assembly 15 may be adapted to attach to military aircraft, such as jets, as shown in, for example, FIGS. 8-10. These aircraft are heavier and faster than light civilian aircraft, and the VTOL system must be larger and more powerful, as demonstrated in the Figures. For military aircraft, the tapering of the housing 35 is important to reduce drag and protect the rotor blades from the adverse effects of such drag. The VTOL system assembly 15 may be attached to strong points on the fuselage of the military aircraft using a supporting member 37. The supporting member 37 may comprise any structure or device to add stability, space, or strength to the connection between the housing 35 and the aircraft. It is expected that a pilot skilled in flying this type of military aircraft needs only additional skills in operating multicopter aircraft in order to fly this VTOL fixed wing military jet-powered airplane.

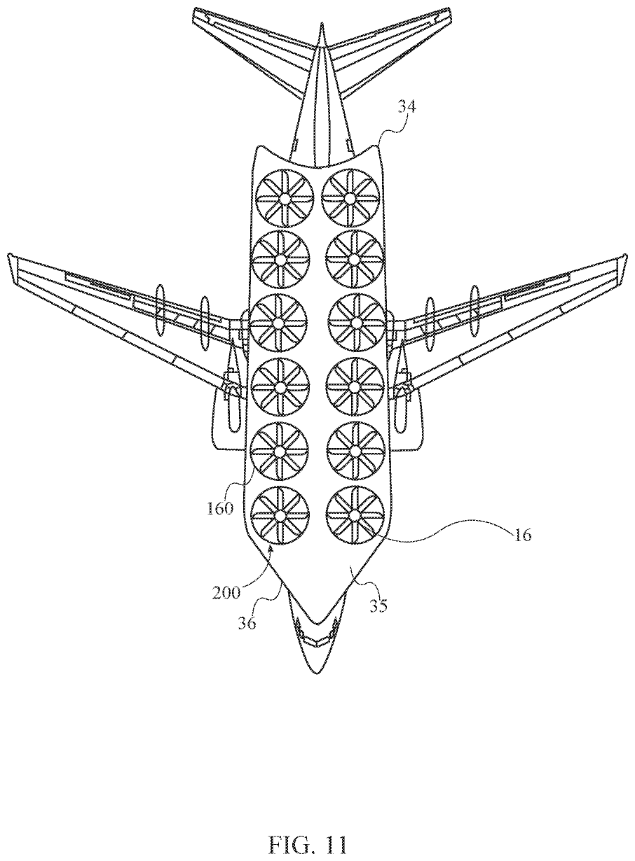

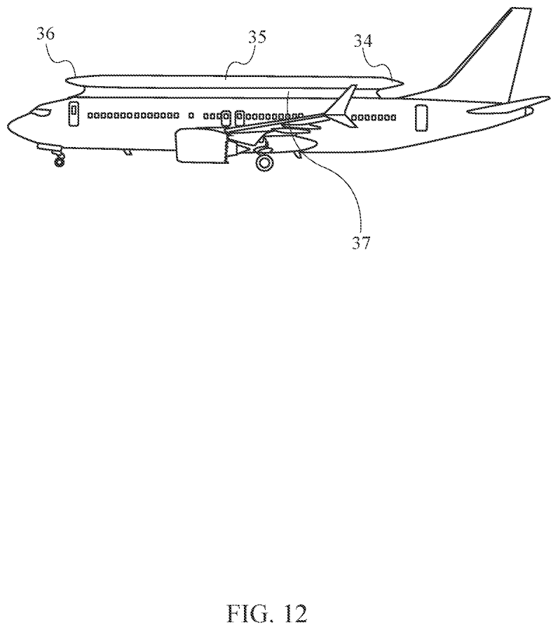

In other embodiments, the VTOL system assembly 15 may be adapted to attach to a commercial passenger aircraft, as shown, for example, in FIGS. 11-12. It has a VTOL system assembly 15, having multiple ducted rotors 16, each having multiple rotor blades inside the slot 200 on the housing 35, all housed in a streamlined housing 35, whose front edge 36 and rear edge 34 are tapered to a fine edge to reduce drag.

The rotors 16 are designed to generate an upward lifting force when rotated at full operational speed so that the total lifting force of all the rotors 16 will provide enough force for vertical take-off and landing of the aircraft. The rotors 16 may be driven by battery-powered electric motors, or by pneumatic motors powered by on-board compressed air, or by combustion engines such as piston engines or turboshaft engines, or a combination of these. These power sources are selected to provide sufficient power for VTOL operation of the aircraft.

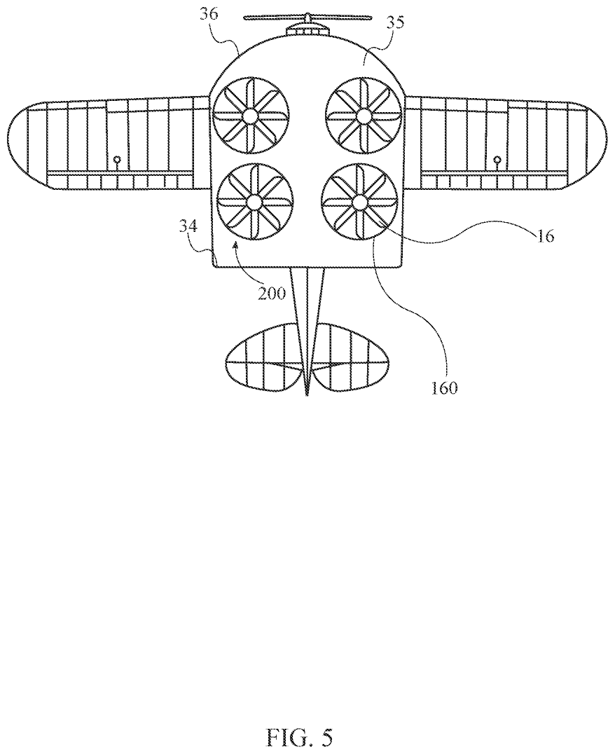

In an embodiment with multiple vertical lift rotors 16, as shown in, for example, FIG. 5, VTOL flight control of the aircraft is done through control means which are similar for multicopters in general. These controls are likewise similar to those of quadcopters which have been described above, which include a left control rod for yaw and elevation control, and a right control rod for pitch and roll control.

In the event that ducted rotors 16 are used, the ducted rotors 16 are powered by electric motors, pneumatic motors or combustion engines which may be either piston engines or turboshaft engines, or by any combination of these. Those engines are designed and selected to provide enough power for VTOL operation. The ducted rotors 16 are designed and selected to produce enough lifting force for VTOL operation of the aircraft.

Although the foregoing description includes instances wherein multiple multicopter rotors 16 may be driven by a common motor via a transmission system, it is to be understood that there may be many instances that it may be advantageous or practical to directly drive each multicopter rotor 16 with its own motor. This may be the case when the motor device 19 are electric motors or pneumatic motors. Although the invention has been explained in relation to its preferred embodiment, it is to be understood that many other possible modifications and variations can be made without departing from the spirit and scope of the invention.

I claim:

1. A Vertical Take Off and Landing (VTOL) system a comprising:
A VTOL system assembly comprising a rotor, a transmission device, a motor device, and a housing;
the rotor comprising a plurality of rotor blades;
an energy source;
a control system;
the transmission device being operatively connected to the motor device and the rotor, such that the transmission device transmits energy from the motor device to the rotor;
the housing further comprising a slot;
the rotor is positioned within the slot;
the slot comprising an upper aperture and a lower aperture;
the control system being operatively connected to the VTOL system assembly.

2. The VTOL system of claim 1, further comprising:
a cover;
the cover further comprising an upper cover and a lower cover;
the upper aperture further comprising the upper cover;
the lower aperture further comprising the lower cover; and
the upper cover and the lower cover being actuated using the control system.

3. The VTOL system of claim 2, further comprising:
the upper cover is attached to the upper aperture using a hinged mechanism; and
the lower cover is attached to the lower aperture using a hinged mechanism.

4. The VTOL system of claim 2, further comprising:
the upper cover is attached to the upper aperture using a sliding mechanism; and
the lower cover is attached to the lower aperture using a sliding mechanism.

5. The VTOL system of claim 1, further comprising:
the rotor comprising an unducted rotor; and
the rotor being adapted to fold into the housing when not in operation.

6. The VTOL system of claim 1, further comprising:
the rotor comprising a ducted rotor.

7. The VTOL system of claim 1, further comprising:
the rotor comprising at least one upper rotor and at least one lower rotor;
the upper rotor is positioned in the upper half of the slot;
the lower rotor is positioned in the lower half of the slot;
a stator blade;
the upper rotor and lower rotor are contrarotating; and
the stator blade is positioned between the upper rotor and the lower rotor.

8. The VTOL system of claim 1, further comprising:
the rotor further comprising at least one main rotor and at least one auxiliary rotor;
the main rotor is static to provide lift; and
the auxiliary rotor is rotatable to provide pitch and roll.

9. The VTOL system of claim 1, further comprising:
the energy source comprising a rechargeable battery; and
the energy source being adapted to power the motor device.

10. The VTOL system of claim 1, further comprising:
the housing further comprising a front edge and a rear edge;
wherein the front edge is tapered; and
wherein the rear edge is tapered.

11. The VTOL system of claim 1, further comprising:
a plane;
the housing is attached to the plane; and
the housing is positioned directly above the fuselage of the plane.

12. The VTOL system of claim 1, further comprising:
the control system comprising a left rod and a right rod;
the left rod being adapted to control vertical and yaw maneuvers of the VTOL system assembly; and
the right rod controlling pitch and roll maneuvers of the VTOL system assembly.

13. A Vertical Take Off and Landing (VTOL) system a comprising:
A VTOL system assembly comprising a rotor, a transmission device, a motor device, and a housing;
the rotor comprising a plurality of rotor blades;
an energy source;
a control system;
a plane;
the transmission device being operatively connected to the motor device and the rotor, such that the transmission device transmits energy from the motor device to the rotor;
the housing further comprising a slot;
the rotor being positioned within the slot;
the slot comprising an upper aperture and a lower aperture;
the rotor being adapted to fold into the housing when not in operation;
a cover;
the cover further comprising an upper cover and a lower cover;
the upper aperture further comprising the upper cover;
the lower aperture further comprising the lower cover;
the upper cover and the lower cover being actuated using the control system;
the rotor comprising at least one upper rotor and at least one lower rotor;
the upper rotor is positioned in the upper half of the slot;
the lower rotor is positioned in the lower half of the slot;
a stator blade;
the upper rotor and lower rotor and contrarotating;
the stator blade is positioned between the upper rotor and the lower rotor the housing is attached to the plane;
the housing is positioned directly above the fuselage of the plane;
the housing further comprising a supporting member, a front edge and a rear edge;
the supporting member is attached to the plane;
wherein the front edge is tapered;
wherein the rear edge is tapered;
the control system being operatively connected to the VTOL system assembly;
the control system comprising a left rod and a right rod;
the left rod being adapted to control vertical and yaw maneuvers of the VTOL system assembly; and
the right rod controlling pitch and roll maneuvers of the VTOL system assembly.

14. The VTOL system of claim 13, further comprising:
the upper cover is attached to the upper aperture using a hinged mechanism; and
the lower cover is attached to the lower aperture using a hinged mechanism.

15. The VTOL system of claim 13, further comprising:
the upper cover is attached to the upper aperture using a sliding mechanism; and
the lower cover is attached to the lower aperture using a sliding mechanism.

16. The VTOL system of claim 13, further comprising:
the rotor comprising an unducted rotor.

17. The VTOL system of claim 13, further comprising:
the rotor comprising a ducted rotor.

18. The VTOL system of claim 13, further comprising:
the rotor further comprising at least one main rotor and at least one auxiliary rotor;
the main rotor being adapted to provide lift and remain static; and
the auxiliary rotors are adapted to be rotatable to provide pitch and roll.

19. The VTOL system of claim 13, further comprising:
the energy source comprising a rechargeable battery; and
the energy source being adapted to power the motor device.

20. A Vertical Take Off and Landing (VTOL) system a comprising:
A VTOL system assembly comprising a rotor, a transmission device, a motor device, and a housing;
the rotor comprising a plurality of rotor blades;
an energy source;
a control system;
a plane;
the transmission device being operatively connected to the motor device and the rotor, such that the transmission device transmits energy from the motor device to the rotor;
the housing further comprising a slot;
the rotor being positioned within the slot;
the slot comprising an upper aperture and a lower aperture;
the rotor being adapted to fold into the housing when not in operation;
a cover;
the cover further comprising an upper cover and a lower cover;
the upper aperture further comprising the upper cover;
the lower aperture further comprising the lower cover;
the upper cover and the lower cover being actuated using the control system;
the rotor comprising at least one upper rotor and at least one lower rotor;
the upper rotor is positioned in the upper half of the slot;
the lower rotor is positioned in the lower half of the slot;
a stator blade;
the upper rotor and lower rotor and contrarotating;
the stator blade is positioned between the upper rotor and the lower rotor the housing is attached to the plane;
the housing is positioned directly above the fuselage of the plane;
the housing further comprising a supporting member, a front edge and a rear edge;
the supporting member is attached to the plane;
wherein the front edge is tapered;
wherein the rear edge is tapered;
the control system being operatively connected to the VTOL system assembly;
the control system comprising a left rod and a right rod;
the left rod being adapted to control vertical and yaw maneuvers of the VTOL system assembly;
the right rod controlling pitch and roll maneuvers of the VTOL system assembly;
the upper cover is attached to the upper aperture using a hinged mechanism;
the lower cover is attached to the lower aperture using a hinged mechanism;
the rotor comprising an unducted rotor;
the rotor further comprising at least one main rotor and at least one auxiliary rotor;
the main rotor being adapted to provide lift and remain static;
the energy source comprising a rechargeable battery;
the energy source being adapted to power the motor device; and
the auxiliary rotors are adapted to be rotatable to provide pitch and roll.
